(19) United States
(12) Patent Application Publication
(10) Pub. No.: US 2019/0231054 A1
(43) Pub. Date: Aug. 1, 2019

(54) Fishing Gear Harness Assembly

(71) Applicant: CLAM CORPORATION, Rogers, MN (US)

(72) Inventor: Thomas A. Walter, Cologne, MN (US)

(21) Appl. No.: 15/882,141

(22) Filed: Jan. 29, 2018

(51) Int. Cl. A45F 3/04; A01K 97/10; A01K 97/12

(52) U.S. Cl. CPC A45F 3/047; A01K 97/01; A01K 97/125; A01K 97/10

(57) ABSTRACT

A fishing gear harness assembly including at least one flexible, adjustable member to be worn by a user, the at least one flexible, adjustable member having a forward portion and a rearward portion, a battery container connected to and extending rearward from the rearward portion and being configured to enclose a battery, a mount releasably connected to the forward portion and being configured to support at least one marine electronics unit that includes at least one electronic display and a submersible portion, and a power cable extending from the battery container and toward the front portion.

### BACKGROUND OF THE INVENTION

### Field of the Invention

The present invention generally relates to ways to conveniently carry, hold and/or use fishing gear, and more particularly to a fishing gear harness assembly that may be worn by a user to conveniently carry, hold and/or use various fishing gear.

### Discussion of the Prior Art

Depending on the type of fishing involved, a fisher or angler may need to use or have on-hand various equipment. This is especially true for ice fishing, where one may need to carry and use items such as a fish or depth finder, a GPS device, rods, a skimmer for removing ice that forms in a hole that has been cut in the ice, and a variety of other gear that may include lures or bait, fishing line, weights, bobbers or other items. It also may be advantageous for the angler to be able to carry a mobile communications device, such as a cellular telephone or walkie talkie. Such a collection of gear could take 4 hands to carry, and cannot readily be held while operating some portion of the equipment. This can be inconvenient to an angler who must make multiple trips to transport such items or who may need to constantly be setting down items when trying to work with others. Given the conditions when ice fishing, this extra burden can be not only time consuming, but frustrating.

### SUMMARY OF THE INVENTION

The purpose and advantages of the invention will be set forth in and apparent from the description and drawings that follow, as well as will be learned by practice of the claimed subject matter.

This disclosure generally provides a fishing gear harness assembly that enables a user to carry and operate fishing gear more conveniently. The fishing gear may be carried in a hands-free manner and the harness assembly accommodates at least one marine electronics unit that includes at least one electronic display and a submersible portion. For example, this may include a fish or depth finder with a submersible transducer. Such equipment requires a power source, and the fishing gear harness assembly has a rear portion to which a battery container is connected to hold a battery. The battery may provide power to operate the at least one marine electronics unit and/or other electronic equipment, such as a GPS device, cellular telephone or other equipment. The harness assembly includes a forward portion that has a mount that holds the marine electronics unit, and a power cable extends from the battery container toward the forward portion. For comfort, items can be conveniently carried and then disconnected from the harness assembly when not presently needed. Similarly, the harness assembly may be removed and placed nearby to have everything needed in one location.

The fishing gear harness assembly may include a flexible, adjustable belt and/or a shoulder harness. The harness assembly may include numerous other features for convenience. For example, the power cable may be connected directly to the at least one marine electronics unit or may be connected to a power supply hub that, in turn, may be connected to the unit and to additional devices. The harness assembly also my include a connector for carrying and/or operating a GPS device or mobile communications device, a fishing rod holder and/or skimmer holder, a pouch for carrying additional items. The harness assembly provides a user a unique opportunity to carry items in a hands-free manner and more convenient operation of various equipment because it is supported by the harness assembly, permitting the user to focus on operating the equipment, as opposed to merely holding it.

In a first aspect, this disclosure provides a fishing gear harness assembly including at least one flexible, adjustable member to be worn by a user, a battery container connected to and extending outward from the at least one flexible, adjustable member and being configured to enclose a battery, a mount releasably connected to the at least one flexible, adjustable member and being configured to support at least one marine electronics unit that includes at least one electronic display and a submersible portion, and a power cable extending from the battery container.

It is to be understood that both the foregoing general description and the following detailed description are exemplary and provided for purposes of explanation only, and are not restrictive of the subject matter claimed. Further features and objects of the present disclosure will become more fully apparent in the following description of the preferred embodiments and from the appended claims.

### BRIEF DESCRIPTION OF THE DRAWINGS

In describing the preferred embodiments, reference is made to the accompanying drawing figures wherein like parts have like reference numerals, and wherein:

FIG. 1 is a front right perspective view of an example fishing gear harness assembly being worn by a user.

FIG. 2 is a front left perspective view of the example fishing gear harness that is being worn by a user and is shown in FIG. 1.

FIG. 3 is a rear perspective view of the example fishing gear harness assembly that is being worn by a user and is shown in FIG. 1.

FIG. 4 is an upper rear perspective view of the battery container of the example fishing gear harness shown in FIG. 3.

FIG. 5 is a closer view of a mount connected to a forward portion of the example fishing gear harness assembly of FIG. 1 that is being disconnected.

FIG. 6 is a front left perspective view of the example fishing gear harness assembly of FIG. 1 showing example ways of connecting elements to the harness assembly.

FIG. 7 is a front right perspective view of a second example fishing gear harness assembly.

FIG. 8 is a rear perspective view of the second example fishing gear harness shown in FIG. 6.

FIG. 9 is a right side perspective view of a third example fishing gear harness assembly being worn by a user.

FIG. 10 is a front left perspective view of an accessory mount to a shoulder strap portion that may be used on a fishing gear harness assembly of one of the preceding examples.

FIG. 11 is a front perspective view of a further accessory mount to a belt portion that is being disconnected and may be used on a fishing gear harness assembly of one of the preceding examples.

FIG. 12 is a right side perspective view of a fourth example fishing gear harness assembly being worn by a user.

It should be understood that the drawings are not to scale. While some mechanical details of example floors and shelters, including other plan and section views of the examples shown and of examples that may have alternative configurations, have not been included, such details are considered well within the comprehension of those of skill in the art in light of the present disclosure. It also should be understood that the present invention is not limited to the example embodiment illustrated.

### DETAILED DESCRIPTION OF THE PREFERRED EMBODIMENTS

For the following defined terms, these definitions shall be applied, unless a different definition is given in the claims or elsewhere in this disclosure. As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise.

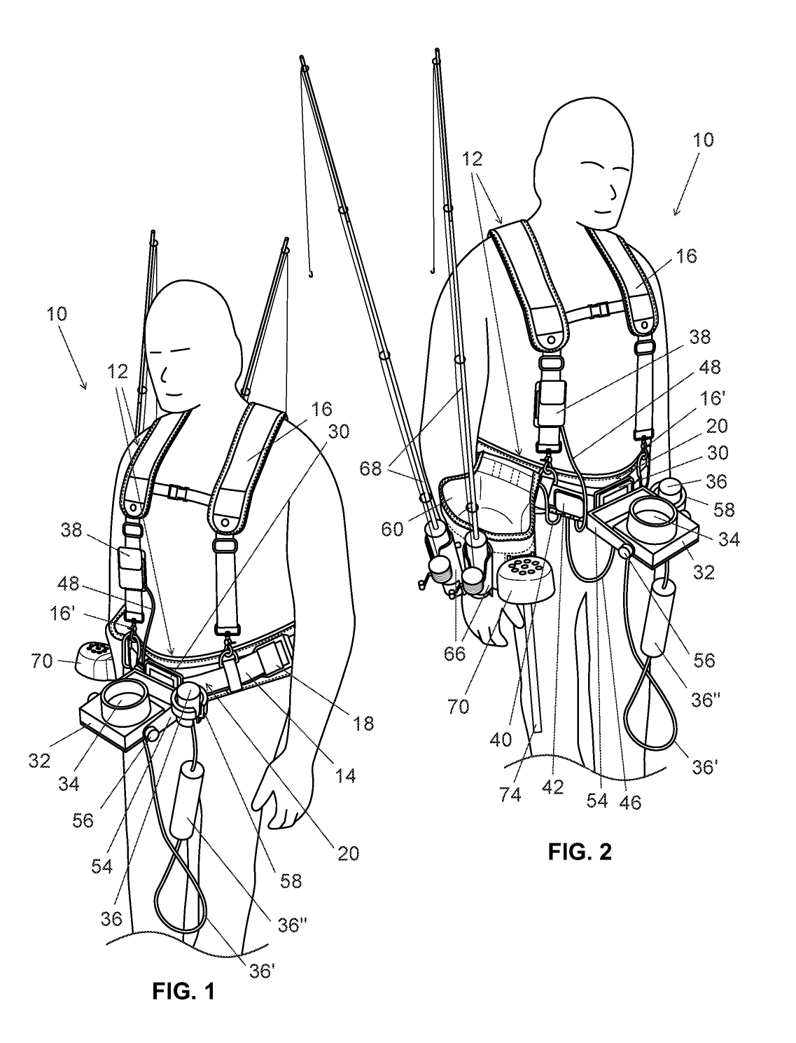

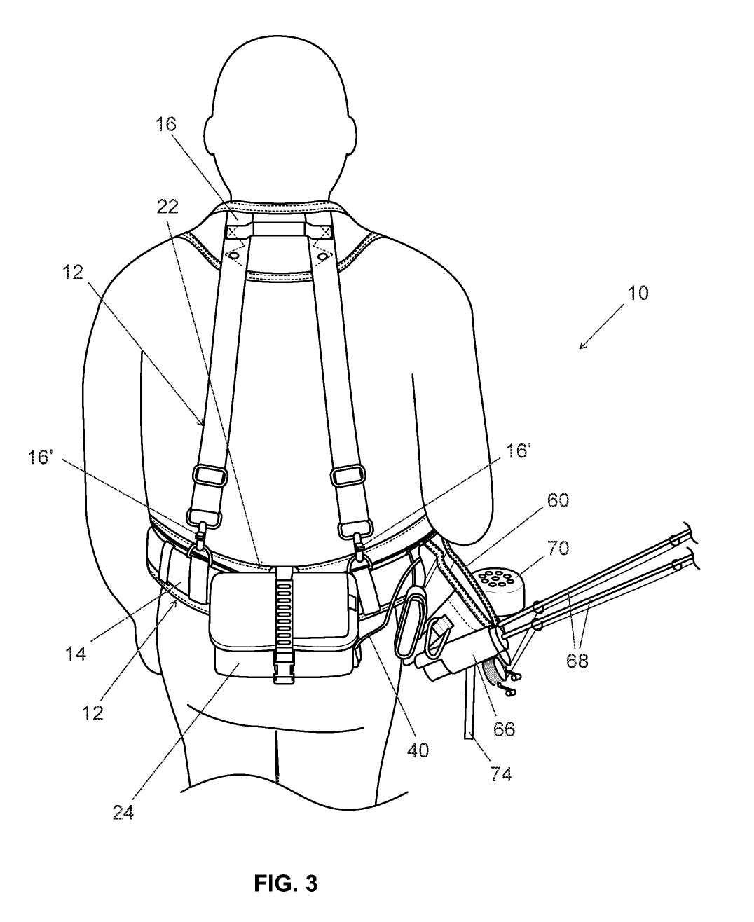

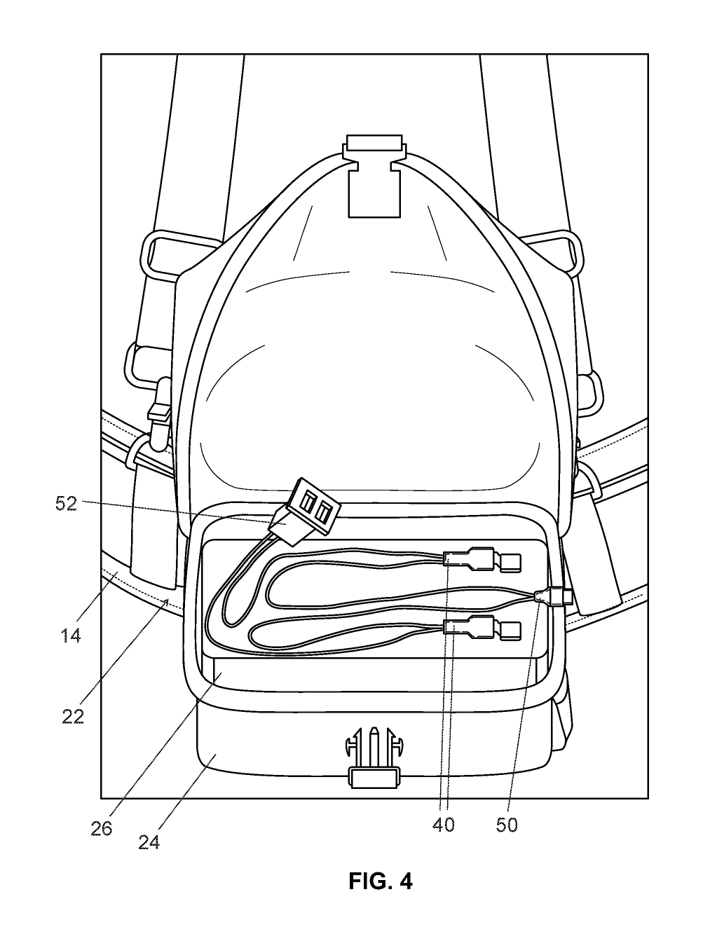

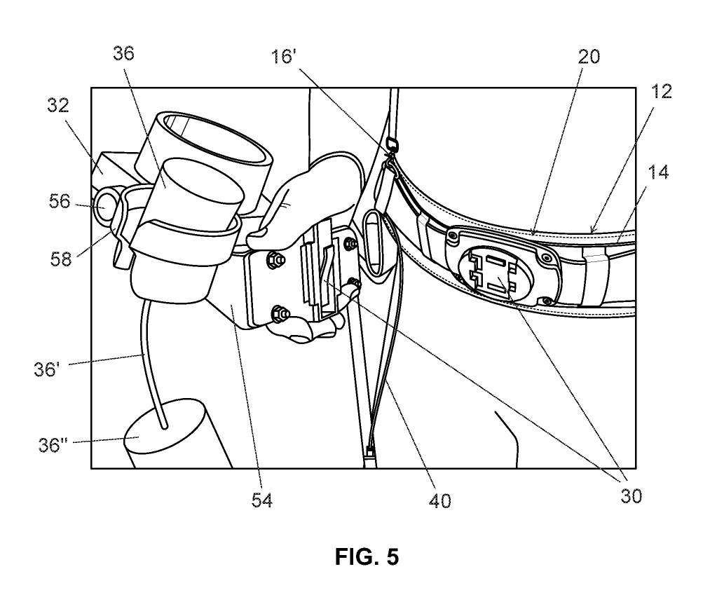

Referring generally to FIGS. 1-12, it will be appreciated that fishing gear harness assemblies of the present disclosure generally may be embodied within numerous configurations, and may be used in various ways to alter and enhance the convenience of users. Indeed, while acknowledging that all of the example configurations of fishing gear harness assemblies need not be shown herein, examples are provided and described to better demonstrate that a variety of configurations and methods of use are contemplated.

Turning to FIGS. 1-6, a first example embodiment of a fishing gear harness assembly 10 is shown in a configuration that may be worn by a user. The fishing gear harness assembly 10 includes at least one flexible, adjustable member 12 to be worn by a user. The at least one flexible, adjustable member 12 may include a belt 14 and/or shoulder strap assembly 16, with either being of a separate construction to be worn over a user's clothing or outer wear, or may be incorporated into a garment, such as a vest or jacket. If both a belt 14 and shoulder strap assembly 16 are included, the two portions could be integrated into a single flexible, adjustable harness, or the two may be of separate construction and the shoulder strap assembly 16 may have fasteners 16′ that are connected to and support the belt 14.

The at least one flexible, adjustable member 12 may be referred to as having a forward portion 20 and a rearward portion 22. A battery container 24 is connected to and extending outward from the at least one flexible, adjustable member 12 and is configured to enclose a battery 26, which preferably is rechargeable. The fishing gear harness assembly also includes a mount 30 releasably connected to the at least one flexible, adjustable member 12 and is configured to support at least one marine electronics unit 32 that includes at least one electronic display 34 and a submersible portion 36. While other equipment may be used, the submersible portion 36 shown in this example is a transducer that is at the end of a cable 36′ that is connected to the at least one marine electronics unit 32, and a float 36″ is located along the length of the cable 36′. Also, it will be appreciated that the battery container 24 and mount 30 may be located at any position on the at least one flexible, adjustable member 12, whether either happens to be along the front, rear or a side of a belt, or of a shoulder strap assembly. Indeed the fishing gear harness assembly 10 may be configured to have one or more of the components be connectable at multiple locations on the at least one flexible, adjustable member 12.

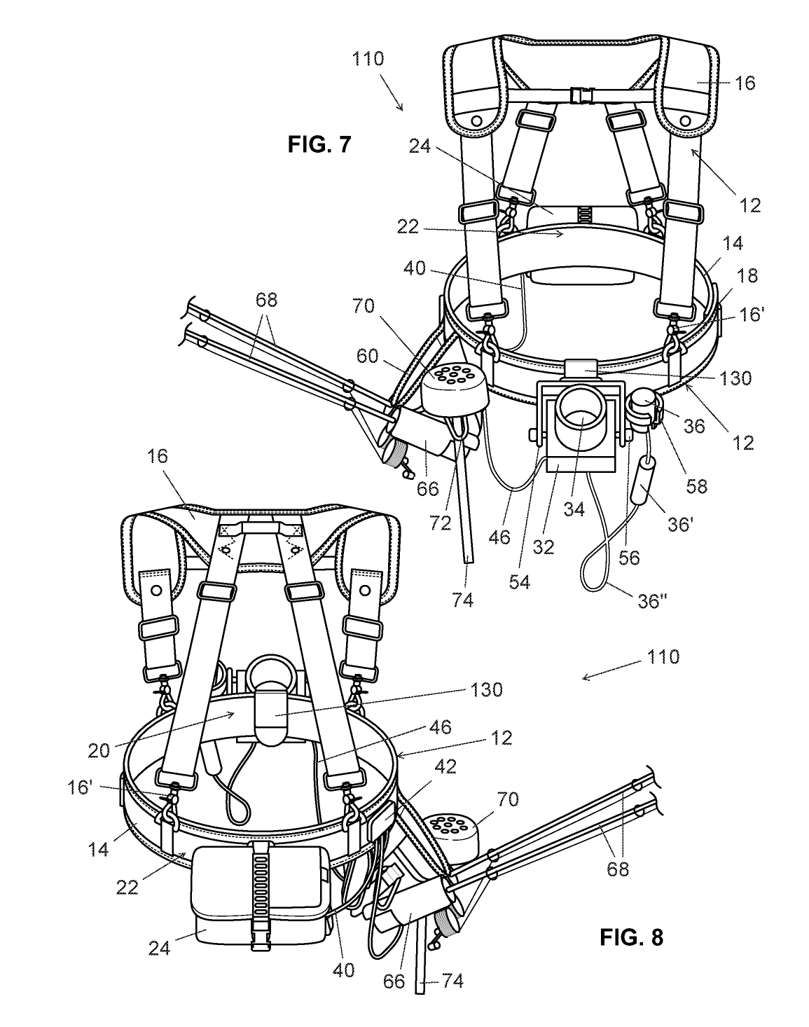

In the first example shown, the mount 30 includes a first portion that stays connected to the belt 14 and a second portion that stays connected to the unit 32, however, the mount could be of a single portion that stays with the belt 14 or with the unit 32, and while being configured to connect to the respective opposed component, as is shown in FIGS. 7 and 8 with respect to the second example. A power cable 40 extends from the battery container 24. In this first example, the power cable 40 extends from the battery container 24 and toward the front portion 20. It will be appreciated that reference herein to a cable may refer to a single wire or multiple wires, whether such are running individually or are banded together within a single outer casing.

As noted above and shown in the drawings, the at least one flexible, adjustable member 12 may include an elongated belt 14 being adjustable in length and having a connector 18 that releasably retains the belt 14 in a closed encircling position around a user. This may be appreciated in FIG. 1. The connector 18 on the at least one flexible, adjustable member 12 may be of any suitable construction, such as being in the form of a buckle, latch, clip, hook and loop fastener, or other type of quick disconnect fastener or the like, and may be located in any position around the periphery of the belt 14.

In the first example, as seen in FIGS. 1-6, the belt 14 includes the forward portion 20 of the at least one flexible, adjustable member 12 to which the mount 30 is releasably connected and the rear portion 22 to which the battery container 24 is connected. The power cable 40 extending forward may be connected to a power supply hub 42, such as a power supply hub 42 that provides multiple ports 44, for USB or other electrical cable connectors. In the first example, the power supply hub 42 is shown connected to the front portion 20 at the belt 14, but it will be appreciated that it may be connected to the at least one flexible, adjustable member 12, whether it includes a belt 14 or shoulder strap assembly 16, and at any location on the at least one flexible, adjustable member 12, which may be on a front, rear or side portion of the belt 14 and/or shoulder strap assembly 16.

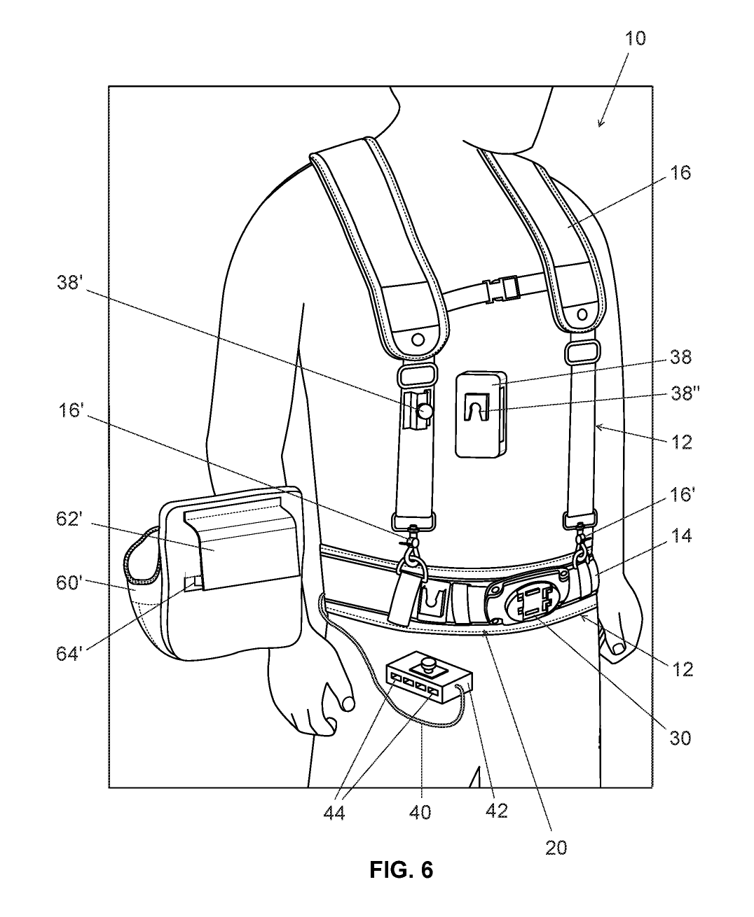

The power supply hub 42 may be used to provide power from the battery 26 to multiple electronic devices. For instance, the power cable 40 extends from its connection to the battery 26 at one end and is connected to the power supply hub 42 at a second end. In turn, a cable 46 may be connected to the power supply hub 42 and configured for connection to the at least one marine electronics unit 32, while a different cable 48 may be connected to the power supply hub 42 and configured for connection to another electronic device 38, such as a GPS device, mobile communications device, or other electronic accessory. The additional electronic device 38 may be removably connected with or without a protective case or pouch. The at least one flexible, adjustable member 12 includes a mount 38′ for the electronic device 38, best seen in FIG. 6 as having a post that fits into a complementary slot 38″ on the electronic device 38 on a front adjustable strap of the shoulder strap assembly 16. In addition, in any of the examples herein, the power cable 40 extending from the battery may be constructed to include a battery recharging electrical connector 50, for connection to a battery recharger, and/or a power supply hub 52 located within the battery container 24, for connection to one or more power supply cables, such as power supply cable 40.

The mount 30 may be adjustable to select a viewing angle for the electronic display 34 of the at least one marine electronics unit 32. For example, the mount 30 may include a bracket 54 that connects to a body of the at least one marine electronics unit 32. Such a connection may provide for pivotal or other movement of the unit 32 relative to the mount 30 by use of thumbscrews 56 or other adjustable components, fasteners or the like. The mount 30 also may include a holder 58 that is configured to releasably support the submersible potion 36 of the at least one marine electronics unit 32, whether by being holstered, clamped or otherwise held in a stowed position.

The example fishing gear harness assembly 10 may further include features that provide for additional improved convenience. For instance, a pouch 60 may be connected to the at least one flexible, adjustable member 12. The pouch may feature one or more generic large receptacles to receive all types of fishing related or other supplies, may include one or more smaller receptacles, or may be of custom construction to conveniently house certain gear or supplies in separate, particularly configured compartments. It will be appreciated that the pouch 60 may be permanently connected to the at least one flexible, adjustable member 12, as shown in FIGS. 1-3. Alternatively, the pouch may be removably connected thereto, such as is shown in FIG. 6, wherein the pouch 60′ includes a large flap 62′ that goes over the belt 14 and is held in place by fasteners, such as hook and loop fasteners 64′.

An angler may wish to carry fishing rods, and the fishing gear harness assembly 10 may include a fishing rod holder 66 that is connected to the at least one flexible, adjustable member 12, for carrying fishing rods 68. Example, additional useful items for an ice angler are a skimmer 70, which can be used to remove ice as it is starting to form in an open hole through the ice. A handle holder 72, such as in the form of a loop (best seen in FIG. 7) or other suitable construction, may be utilized in any of the examples herein. The handle holder 72 may be connected to the at least one flexible, adjustable member 12 directly or via connection to another component, such as the pouch 60. The handle holder 72 receives a handle portion 74 of the skimmer 70 or alternatively the handle of a fish net or other fishing gear.

Turning to FIGS. 7 and 8, a second example fishing gear harness assembly 110 is shown. Many of the components within the assembly 110 are the same as were shown and described with respect to the first example 10 shown in FIGS. 1-6, so they need not be described again. For instance, the at least one flexible, adjustable member 12, belt 14 and shoulder strap assembly 16 are the same as were shown. The battery container 24 holding a battery, at least one marine electronics unit 32, fishing rod holder 66 and handle holder 72, and associated hardware are the same as were shown and described for the first example. However, there are a few differences that will be described.

For example, the fishing gear harness assembly 110 includes a releasable mount 130 that is connected to the bracket 54 on the at least one marine electronics unit 32, and the releasable mount 130 is shown as a clip that slides over and is connected to the front portion 20 of the belt 14. This provides an example of an alternative releasable mount that permits the unit 32 to be quickly and conveniently released from the harness assembly 110. Another of the differences is in the location of the power supply hub 42. In the second example, the power supply hub 42 is connected to the rear portion 22 of the at least one flexible, adjustable member 12, such as is shown in FIG. 8 on the rear right side of the belt 14. However, the second example fishing gear harness assembly 110 of FIGS. 7 and 8 does not include another electronic device 38 shown in the first example, such as a GPS device, mobile communications device, or other electronic accessory.

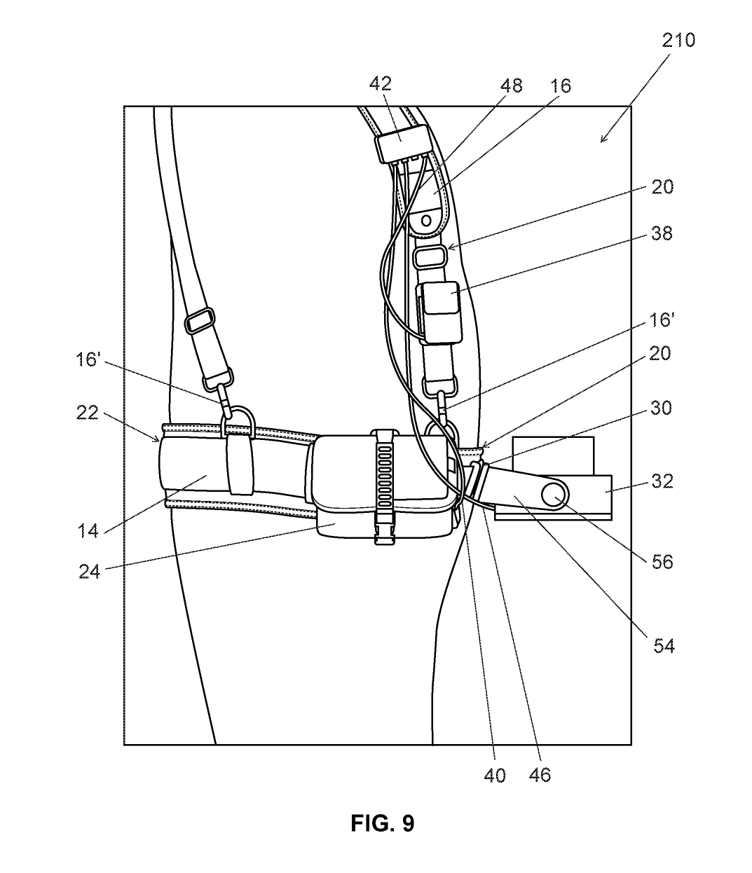

A third example fishing gear harness assembly 210 is shown in FIG. 9. As with the second example, many of the components within the assembly 210 are the same as were shown and described with respect to the first example 10 shown in FIGS. 1-6, so they need not be described again. For instance, the at least one flexible, adjustable member 12, belt 14 and shoulder strap assembly 16 are the same as were shown. Other similar items of the third example include the battery container 24 holding a battery, at least one marine electronics unit 32 connected to a bracket 54 of a releasable mount 30 that is connected to a front portion 20 of the belt 14 of the at least one flexible, adjustable member 12.

However, the third example also includes a few differences. For instance, the fishing gear harness assembly 210 includes the power supply hub 42 connected to a front portion 20 of the at least one flexible, adjustable member 12 by being connected to an upper front portion of the shoulder strap assembly 16. The battery container 24 for holding a battery extends outward from the belt 14 of the at least one flexible, adjustable member 12, but in this example it is located along a side of the belt 14. This may provide enhanced access to the battery and the cables while the fishing gear harness assembly 210 is being used. Accordingly, the power cable 40 may be connected at one end to the power supply hub 42 that is connected to the shoulder strap assembly 16 and at the other end to a battery in the battery container 24. Similarly, the shoulder strap assembly 16 includes a mount for an electronic device 38, such as a GPS device, mobile communications device, or other electronic accessory, to be connected to a front portion 20 of the at least one flexible, adjustable member 12 by being connected to a front adjustable strap of the shoulder strap assembly 16. A cable 48 may be connected to the electronic device 38 and to the power supply hub 42 or directly to the battery. The mount for the electronic device 38 may be similar to that which is shown in FIG. 6, or may be of other suitable construction. The at least one marine electronics unit 32 in FIG. 9 may be of a different type than that which is shown in FIG. 1, but if of the same type, it simply is shown without the additional components relating to a transducer, for ease of viewing.

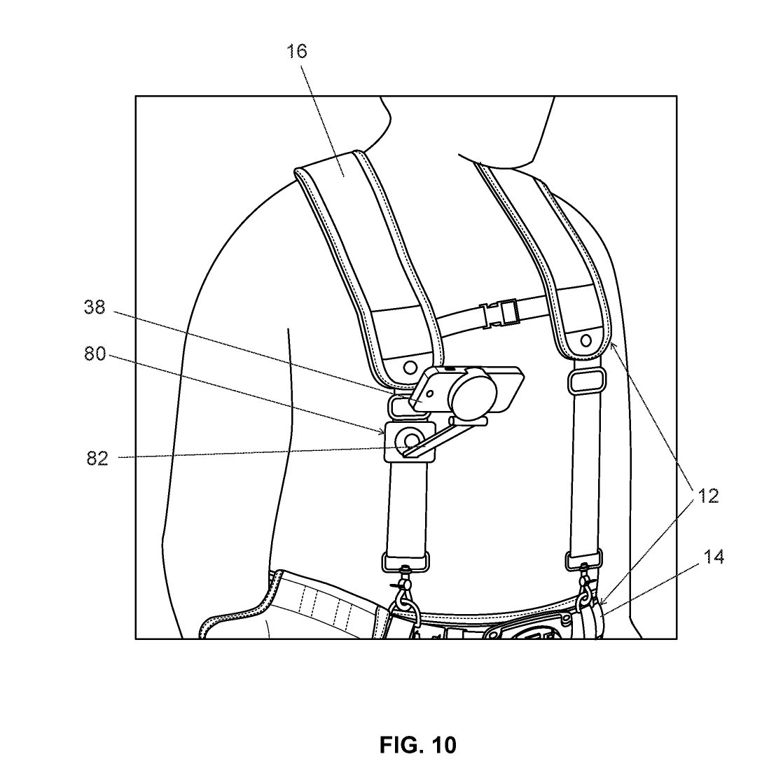

FIG. 10 shows a desirable alternative accessory that may be used with any of the versions of the fishing gear harness assembly 10, 110, 210 that include a shoulder harness assembly 16. Thus, the at least one flexible, adjustable member further includes a mount 80 for a GPS device or mobile communications device, or other electronic device. The mount 80 in FIG. 10 includes a bracket constructed as an articulating arm 82, and the mount 80 is configured to be connected to the shoulder strap assembly 16, as well as to the electronic device 38. The bracket 82 of the mount 80 is adjustable to permit a user to extend the articulating arm forward for more convenient viewing of the electronic device 38.

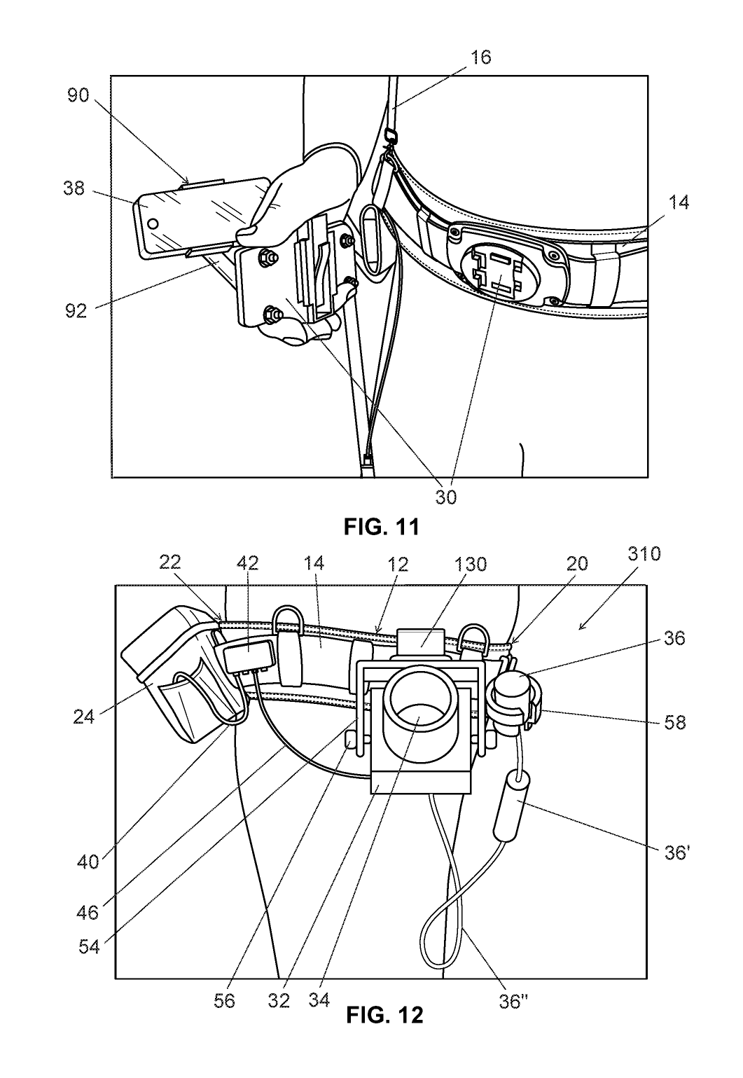

FIG. 11 shows a further alternative accessory that may be used with any of the versions of the fishing gear harness assembly 10, 110, 210 that include a belt 14. Thus, the at least one flexible, adjustable member further includes a mount 90 for a GPS device or mobile communications device, or other electronic device. The mount 90 in FIG. 11 includes a bracket constructed as an articulating arm 92 and is configured to be connected at a first end to the releasable mount 30 on the belt 14, as well as to be connected at a second end to the electronic device 38. The bracket 92 of the mount 90 is adjustable to permit a user to extend the articulating arm forward for more convenient viewing of the electronic device 38.

Turning to FIG. 12, a fourth example fishing gear harness assembly 310 is shown. Some of the components within the assembly 310 are the same as were shown and described with respect to the first example 10 shown in FIGS. 1-6, so they need not be described again. For instance, the battery container 24 holding a battery and the at least one marine electronics unit 32 are the same as were shown and described for the first example.

However, the fourth example also includes a few differences. For instance, the at least one flexible, adjustable member 12 of the fourth example 310 is shown with the belt 14 but not with a shoulder strap assembly 16. Thus, the shoulder strap assembly 16 would be optional. Another of the differences is in the location of the power supply hub 42. In this fourth example, the power supply hub 42 is connected to the side or a rear portion 22 of the at least one flexible, adjustable member 12, similarly to that which is shown in FIG. 8 for the second example. A releasable mount 130 also is similar to that which is shown for the second example in FIGS. 7 and 8, but extends outward from the right side of the belt 14 of the at least one flexible, adjustable member 12. A bracket 54 is connected to the mount 130 and supports the at least one marine electronics unit 32. Additionally, the fourth example fishing gear harness assembly 310 of FIG. 12 does not include a pouch 60, or another electronic device 38 that is shown in the first example, such as a GPS device, mobile communications device, or other electronic accessory. It will be appreciated that the location of the components along the at least one flexible, adjustable member 12 can vary, as well as the selection of components for connection thereto. For instance, the at least one electronics unit 32 in FIG. 12 may be of a different type than that which is shown in FIG. 1.

From the above disclosure, it will be apparent that fishing gear harness assemblies constructed in accordance with this disclosure may include a number of structural aspects that provide numerous advantages to an angler. The example constructions shown herein may exhibit one or more of the above-referenced potential advantages, depending upon the specific design chosen.

It will be appreciated that a fishing gear harness assembly constructed in accordance with the present disclosure may be provided in various configurations. Any variety of suitable materials of construction, configurations, shapes and sizes for the components and methods of connecting the components of the assembly may be utilized to meet the particular needs and requirements of an end user. It is to be understood that the invention is not to be limited to the disclosed example embodiments, but rather, is intended to cover various modifications and equivalent arrangements include within the spirit and scope of the appended claims. Thus, the description and drawings should be considered illustrative and not restrictive of the invention, which is limited only by the appended claims and their legal equivalents.

1. A fishing gear harness assembly comprising:
at least one flexible, adjustable member to be worn by a user;
a battery container connected to and extending outward from the at least one flexible, adjustable member and being configured to enclose a battery;
a mount releasably connected to the at least one flexible, adjustable member and being configured to support at least one marine electronics unit that includes at least one electronic display and a submersible portion; and
a power cable extending from the battery container.

2. The fishing gear harness assembly in accordance with claim 1, wherein the at least one flexible, adjustable member further comprises an elongated belt being adjustable in length and having a connector that releasably retains the belt in a closed encircling position.

3. The fishing gear harness assembly in accordance with claim 1, wherein the connector on the at least one flexible, adjustable member further comprises a buckle or quick disconnect fastener.

4. The fishing gear harness assembly in accordance with claim 2, wherein the belt includes a forward portion to which the mount is releasably connected to the at least one flexible, adjustable member.

5. The fishing gear harness assembly in accordance with claim 2, wherein the belt includes a rear portion to which the battery container is connected.

6. The fishing gear harness assembly in accordance with claim 4, wherein the power cable is connected to a power supply hub that is connected to the at least one flexible, adjustable member.

7. The fishing gear harness assembly in accordance with claim 6, further comprising a cable connected to the power supply hub and configured for connection to the at least one marine electronics unit, a GPS device or mobile communications device.

8. The fishing gear harness assembly in accordance with claim 2, wherein the at least one flexible, adjustable member further comprises a shoulder strap assembly having fasteners that are connected to and support the belt.

9. The fishing gear harness assembly in accordance with claim 8, wherein the shoulder strap assembly further comprises a mount for GPS device or mobile communications device.

10. The fishing gear harness assembly in accordance with claim 8, wherein the power cable is connected to a power supply hub that is connected to the shoulder strap assembly.

11. The fishing gear harness assembly in accordance with claim 10, further comprising a cable connected to the power supply hub and configured for connection to the at least one marine electronics unit, a GPS device or mobile communications device.

12. The fishing gear harness assembly in accordance with claim 1, wherein the power cable is configured for connection to the at least one marine electronics unit.

13. The fishing gear harness assembly in accordance with claim 1, wherein the power cable is connected to a power supply hub.

14. The fishing gear harness assembly in accordance with claim 1, wherein the power cable further comprises a battery recharging electrical connector.

15. The fishing gear harness assembly in accordance with claim 1, wherein the mount is adjustable to select a viewing angle for the electronic display of the at least one marine electronics unit.

16. The fishing gear harness assembly in accordance with claim 1, wherein the mount further comprises a bracket that connects to a body of the at least one marine electronics unit.

17. The fishing gear harness assembly in accordance with claim 1, wherein the mount further comprises a holder for releasably supporting the submersible portion of the at least one marine electronics unit.

18. The fishing gear harness assembly in accordance with claim 1, wherein the at least one flexible, adjustable member further comprises a mount for a GPS device or mobile communications device.

19. The fishing gear harness assembly in accordance with claim 1, further comprising a pouch that is connected to the at least one flexible, adjustable member.

20. The fishing gear harness assembly in accordance with claim 1, further comprising a fishing rod holder that is connected to the at least one flexible, adjustable member.

21. The fishing gear harness assembly in accordance with claim 1, further comprising a handle holder that comprises a loop portion.
